(19) United States
(12) Patent Application Publication
(10) Pub. No.: US 2026/0229717 A1
(43) Pub. Date: Aug. 6, 2026

(54) SECONDARY BATTERY AND ELECTRIC DEVICE

(71) Applicant: NINGDE AMPEREX TECHNOLOGY LIMITED, Ningde (CN)

(72) Inventors: Zhangfei GUO, Ningde (CN); Kai LIU, Ningde (CN)

(73) Assignee: NINGDE AMPEREX TECHNOLOGY LIMITED, Ningde (CN)

(21) Appl. No.: 19/635,127

(22) Filed: Mar. 31, 2026

Related U.S. Application Data
(63) Continuation of application No. PCT/CN2024/137870, filed on Dec. 9, 2024.

(30) Foreign Application Priority Data
Dec. 14, 2023 (CN) 202311727540.5

(51) Int. Cl. H01M 50/517; H01M 50/105

(52) U.S. Cl. CPC H01M 50/517; H01M 50/105; H01M 2220/30

(57) ABSTRACT

A secondary battery includes a secondary battery body and a first connecting member; the secondary battery body has a main portion and a first side sealing edge; the main portion includes a first main wall, a second main wall, and a first side wall; along a first direction, the first main wall and the second main wall are disposed opposite to each other, the first side wall is connected between the first main wall and the second main wall, the first side sealing edge extends out of the first side wall and is folded and fastened to the first side wall. The first connecting member includes a first fastening portion and a first connecting portion connected to the first fastening portion, the first fastening portion is fastened to the first side sealing edge.

### CROSS REFERENCE TO THE RELATED APPLICATIONS

This application is a continuation application of International Application No. PCT/CN2024/137870, filed on Dec. 9, 2024, which claims the benefit of priority of Chinese patent application No. 202311727540.5, filed on Dec. 14, 2023, the contents of which are incorporated herein by reference in its entirety.

### TECHNICAL FIELD

This application relates to the field of battery technology, and in particular, to a secondary battery and an electric device.

### BACKGROUND

In electric devices such as mobile phones, secondary batteries are usually adhesively fastened in battery compartments of the electric devices, for example, by attaching double-sided tape to large surfaces of the secondary batteries. However, this connection method is inconvenient for subsequent disassembly and replacement of the secondary batteries.

### SUMMARY

The purpose of this application is to provide a secondary battery and an electric device, facilitating subsequent disassembly and replacement of the secondary battery.

According to a first aspect of this application, a secondary battery is provided, which includes a secondary battery body and a first connecting member. The secondary battery body has a main portion and a first side sealing edge, the main portion includes a first main wall, a second main wall, and a first side wall; along a first direction, the first main wall and the second main wall are disposed opposite to each other; the first side wall is connected between the first main wall and the second main wall; and the first side sealing edge extends out of the first side wall and is folded and fastened to the first side wall. The first connecting member includes a first fastening portion and a first connecting portion connected to the first fastening portion, the first fastening portion is fastened to the first side sealing edge, the first connecting portion extends beyond one end of the first side sealing edge along a second direction, and the first connecting portion is configured to be detachably connected to an electric device to fasten the secondary battery in a battery compartment of the electric device. The second direction is perpendicular to the first direction.

In the secondary battery according to this application, the secondary battery body may be detachably connected to the electric device through the first connecting member, facilitating subsequent disassembly and replacement of the secondary battery. Specifically, the first connecting member is fastened to a side surface of the secondary battery body, and the secondary battery body is detachably fastened in the battery compartment of the electric device through the first connecting portion. Therefore, there is no need to wrap the secondary battery body with a wrapping film and attach double-sided tape to a large surface of the battery, a longitudinal space of the secondary battery in the third direction is increased, and thus a volumetric energy density of the secondary battery is improved.

In one or more optional embodiments above, the first connecting portion is provided with a first through hole. The first through hole is configured for a threaded fastener to pass through, and the threaded fastener is capable of screw-fastening the first connecting portion to the electric device. The processing difficulty of drilling a hole in the first connecting portion is low, which is beneficial for improving the manufacturing efficiency of the secondary battery. In addition, the secondary battery according to this application adopts threaded connection with high connection strength, and therefore compared with contact pressing to fasten secondary batteries in conventional electric devices such as mobile phones, this improves drop resistance performance of an electric device to cope with conditions such as vibration or impact.

In one or more optional embodiments above, the first connecting portion includes a first connecting segment and a second connecting segment. The first connecting segment extends from one end of the first fastening portion along the second direction. The second connecting segment is connected to the first fastening portion through the first connecting segment, and an extending direction of the second connecting segment is parallel to a third direction. Any two of the third direction, the second direction, and the first direction are perpendicular to each other. The first through hole is provided in the second connecting segment. Thus, the first through hole can face a user directly, and the user can conveniently tighten the threaded fastener to complete the assembly and disassembly of the secondary battery.

In one or more optional embodiments above, the secondary battery includes a second connecting member. The second connecting member includes a second fastening portion and a second connecting portion connected to the second fastening portion. The second fastening portion is fastened to the first side sealing edge. The second connecting portion extends beyond another end of the first side sealing edge along the second direction. The second connecting portion is configured to be detachably connected to the electric device to fasten the secondary battery in the battery compartment of the electric device.

In one or more optional embodiments above, the first fastening portion and the second fastening portion are integrally formed. In other words, the first connecting member and the second connecting member may be two parts on one component, reducing the components required for fastening the secondary battery body, thereby improving the assembly efficiency of the secondary battery.

In one or more optional embodiments above, the second connecting portion is provided with a second through hole. The second through hole is configured for a threaded fastener to pass through, and the threaded fastener can screw-fix the second connecting portion to the electric device. Based on effects similar to those of the first through hole, refer to the effects related to the first through hole. Details are not elaborated herein.

In one or more optional embodiments above, the second connecting portion includes a third connecting segment and a fourth connecting segment. The third connecting segment extends from one end of the second fastening portion along the second direction. The fourth connecting segment is connected to the second fastening portion through the third connecting segment, and an extending direction of the fourth connecting segment is parallel to the third direction. Any two of the third direction, the second direction, and the first direction are perpendicular to each other. The second through hole is provided in the fourth connecting segment. Thus, the second through hole can face the user directly, and the user can further conveniently tighten the threaded fastener to complete the assembly and disassembly of the secondary battery.

In one or more optional embodiments above, the first side sealing edge is a double-folded edge. The first side sealing edge includes a first bending portion, a first extending portion, a second bending portion, and a second extending portion. The first bending portion extends outward from the first side wall. The first extending portion is connected to the first bending portion. The second extending portion is connected to the first extending portion through the second bending portion. The first bending portion, the first extending portion, the second bending portion, and the second extending portion together enclose a slot. The first fastening portion is fastened to the slot.

Due to the structural characteristics of the first bending portion and the second bending portion, even after bending, there is still a certain gap; and the first fastening portion is fastened in the slot formed by the first bending portion and the second bending portion. Then, in the third direction, a width of an entirety formed by the first connecting member and the first side sealing edge is less than a width of an entirety formed with the first connecting member directly fastened to the side of the first extending portion away from the second extending portion. In this way, a volumetric energy density of the secondary battery in the third direction is further increased.

In one or more optional embodiments above, the first extending portion is adhesively fastened to the first side wall, thereby suppressing warping of the first extending portion toward a direction away from the main portion.

In one or more optional embodiments above, the second extending portion is adhesively fastened to the first side wall.

In one or more optional embodiments above, the first extending portion and the second extending portion abut against the first fastening portion. Thus, the first connecting member is partially covered within the first side sealing edge, allowing the first connecting member to connect separately to the second extending portion and the first extending portion, so the first connecting member does not require additional adhesive members for fastening, saving the manufacturing cost of the secondary battery.

In one or more optional embodiments above, the first side sealing edge is a single-folded edge. The first side sealing edge includes a first bending portion and a first extending portion. The first bending portion extends outward from the first side wall. The first extending portion is connected to the first bending portion. The first bending portion, the first extending portion, and the first side wall together enclose a slot. The first fastening portion is fastened to the slot.

According to a second aspect of this application, an electric device is provided, including the secondary battery described above.

Additional aspects and advantages of some embodiments of this application will be partially described, shown, or explained through the implementation of these embodiments of this application.

### BRIEF DESCRIPTION OF DRAWINGS

In order to more clearly illustrate the specific embodiments of this application or the technical solutions in the prior art, the drawings required for the specific embodiments or the description of the prior art will be briefly introduced below. In all drawings, similar elements or parts are generally identified by similar reference signs. In the drawings, the elements or parts are not necessarily drawn to actual scale.

FIG. 1 is a schematic diagram of a structure of a secondary battery detachably fastened to an electric device;

FIG. 2 is a schematic diagram of a structure of a secondary battery provided in a first embodiment of this application;

FIG. 3 is a schematic diagram of another structure of the secondary battery provided in the first embodiment of this application;

FIG. 4 is a cross-sectional view of the secondary battery shown in FIG. 2 along line A-A;

FIG. 5 is a top view of a tab electrically connected to an electrode assembly in the secondary battery shown in FIG. 2;

FIG. 6 is a schematic diagram of a structure of a first connecting member and second connecting member that are separated in the secondary battery shown in FIG. 2;

FIG. 7 is a schematic diagram of a structure of a first connecting member and second connecting member that are connected in the secondary battery shown in FIG. 2;

FIG. 8 is a schematic diagram of another structure of the secondary battery provided in the first embodiment of this application;

FIG. 9 is a schematic diagram of a structure of a first connecting member and second connecting member that are separated in the secondary battery shown in FIG. 8;

FIG. 10 is a schematic diagram of a structure of a first connecting member and second connecting member that are connected in the secondary battery shown in FIG. 8;

FIG. 11 is a schematic diagram of another structure of a first connecting member and second connecting member that are separated in the secondary battery shown in FIG. 2;

FIG. 12 is a schematic diagram of a structure of a secondary battery provided in a second embodiment of this application;

FIG. 13 is a cross-sectional view of the secondary battery shown in FIG. 12 along line B-B;

FIG. 14 is a schematic diagram of a structure of a secondary battery provided in a third embodiment of this application; and

FIG. 15 is a cross-sectional view of the secondary battery shown in FIG. 14 along line C-C.

1. Secondary battery;
10. secondary battery body; 11. pouch bag body; 111. main portion; 1111. first main wall; 1112. second main wall; 1113. first side wall; 1114. second side wall; 1115. third side wall; 1116. fourth side wall; 112. first side sealing edge; 1121. first bending portion; 1122. first extending portion; 1123. second bending portion; 1124. second extending portion; 12. electrode assembly; 121. first electrode plate; 122. second electrode plate; 123. separator; 13. tab; 131. first tab; 132. second tab;
21. first connecting member; 211. first fastening portion; 212. first connecting portion; 2121. first connecting segment; 2122. second connecting segment; 21a. first through hole;
22. second connecting member; 221. second fastening portion; 222. second connecting portion; 2221. third connecting segment; 2222. fourth connecting segment; 22a. second through hole; and
2. electric device.

### DETAILED DESCRIPTION

In order to make the purposes, technical solutions, and advantages of some embodiments of this application clearer, the technical solutions in these embodiments of this application will be clearly described below with reference to the drawings in some embodiments of this application. It is clear that the described embodiments are some but not all embodiments of this application.

Reference to an “embodiment” in this application means that the specific features, structures, or characteristics described with reference to the embodiment may be included in at least one embodiment of this application. The appearance of this phrase in various places in the specification does not necessarily refer to the same embodiment, nor is it an independent or alternative embodiment mutually exclusive with other embodiments.

In the description of this application, it should be noted that, unless otherwise expressly specified and limited, the terms “mounted”, “connected”, and the like should be understood in a broad sense, for example, the terms may indicate a fixed connection, or a detachable connection, or an integral connection; a direct connection, or indirect connection through an intermediate medium; or communication inside two elements. For those of ordinary skill in the art, the specific meanings of the above terms in this application may be understood based on specific circumstances.

The term “perpendicular” describes an ideal state between two components. During actual production or use, the two components may be in an approximately perpendicular state. For example, with reference to numerical description, “perpendicular” may mean that a range for an angle between two straight lines is 90°±10°, “perpendicular” may also mean that a range for a dihedral angle between two planes is 90°±10°, and “perpendicular” may also mean that a range for an angle between a straight line and a plane is 90°±10°. The two components described as “perpendicular” may not be absolutely straight lines or planes, but may alternatively be roughly straight lines or planes, and from a macroscopic view, as long as an overall extending direction is a straight line or plane, the components may be considered as “straight lines” or “planes”.

The term “parallel” describes an ideal state between two components. During actual production or use, the two components may be in an approximately parallel state. For example, with reference to numerical description, “parallel” may mean that a range for an angle between two straight lines is 180°±10°, “parallel” may also mean that a range for a dihedral angle between two planes is 180°±10°, and “parallel” may also mean that a range for an angle between a straight line and a plane is 180°±10°. The two components described as “parallel” may not be absolutely straight lines or planes, but may alternatively be roughly straight lines or planes, and from a macroscopic view, as long as an overall extending direction is a straight line or plane, the components may be considered as “straight lines” or “planes”.

The technical features involved in the different embodiments of this application described below can be combined with each other as long as they do not conflict with each other.

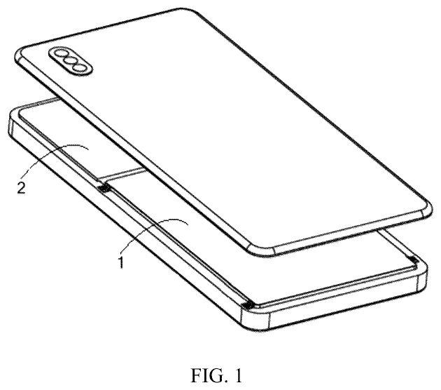

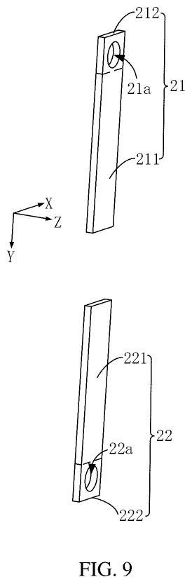

A secondary battery provided in this application may be applied to an electric device to maintain stable operation of the electric device. Examples of such electric device include mobile phones, laptops, tablet computers, game consoles, drones, electric vehicles, electric bicycles, electric tools, and Bluetooth headsets. For ease of understanding, in FIG. 1 to FIG. 15, each embodiment is illustrated with a secondary battery applied to a mobile phone as an example.

FIG. 1 is a schematic diagram of a structure of a secondary battery detachably fastened to an electric device. Refer to FIG. 1. The electric device 2 has a battery compartment adapted to a shape of the secondary battery 1, and a screw hole (not shown) disposed adjacent to a periphery of the battery compartment. One screw hole is configured to cooperate with a first connecting member to be described below, and a threaded fastener (not shown) may pass through the first connecting member and be screw-fixed to one screw hole, locking the secondary battery placed in the battery compartment.

### First Embodiment

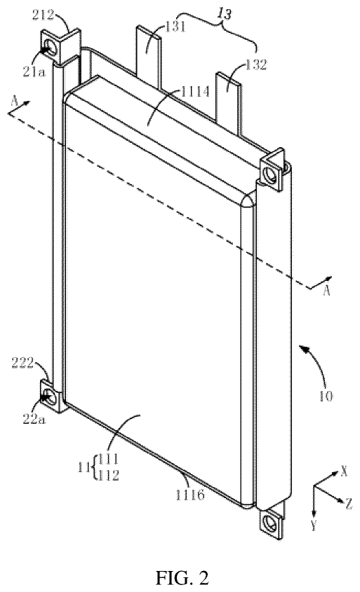

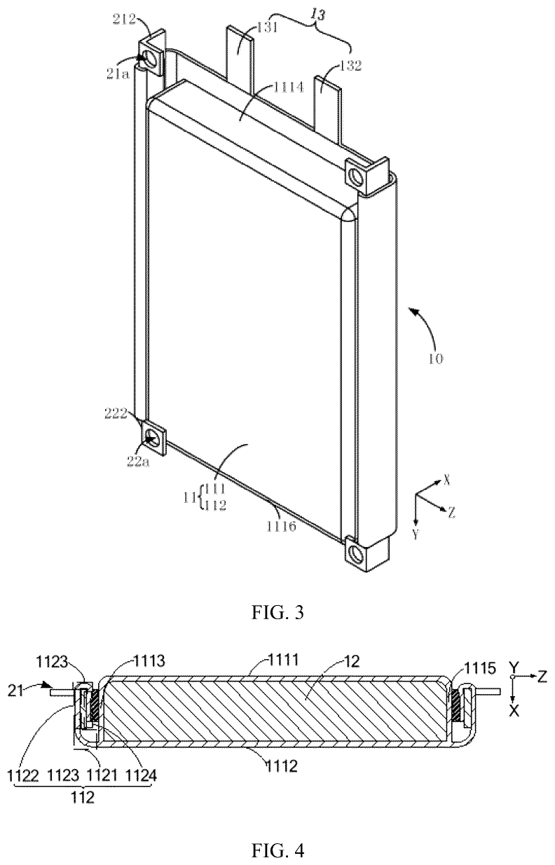

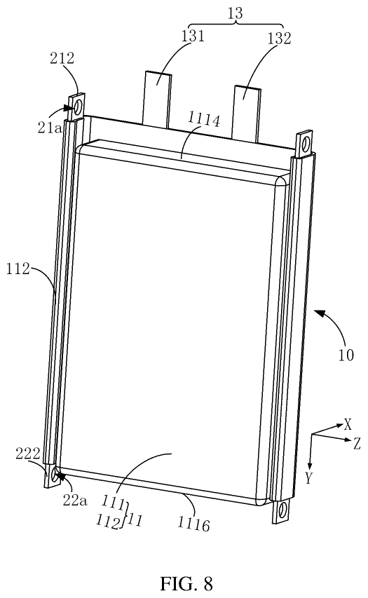

FIG. 2 is a schematic diagram of a structure of a secondary battery provided in a first embodiment of this application. FIG. 3 is a schematic diagram of another structure of the secondary battery provided in the first embodiment of this application. FIG. 8 is a schematic diagram of another structure of the secondary battery provided in the first embodiment of this application.

Refer to FIG. 1 in combination with FIG. 2, FIG. 3, or FIG. 8. The secondary battery includes: a secondary battery body 10 and a first connecting member 21; the secondary battery body 10 cooperates with the electric device through the first connecting member 21 to detachably fasten the secondary battery body 10 in the battery compartment of the electric device. Thus, the replacement of the secondary battery is convenient.

In some embodiments, the secondary battery body 10 is a pouch cell.

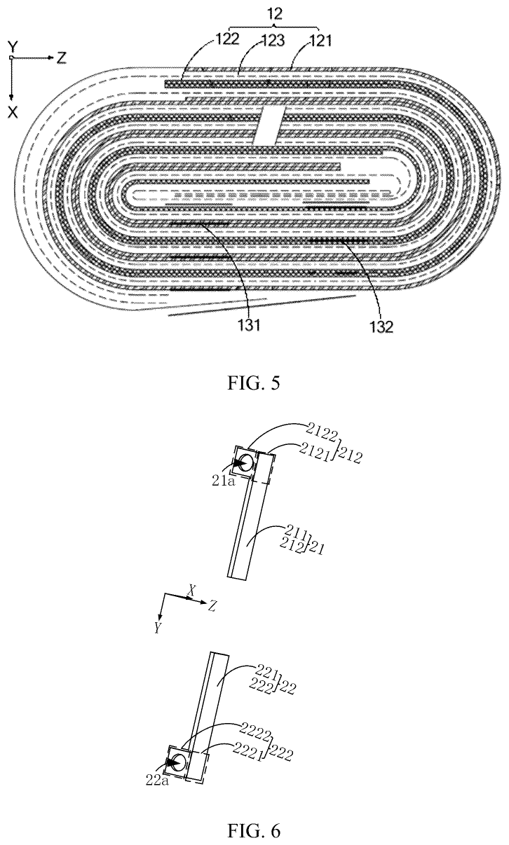

Refer to FIG. 2, FIG. 3, or FIG. 8 in combination with FIG. 5. The secondary battery body 10 includes a pouch bag body 11, an electrode assembly 12, and a tab 13. The pouch bag body 11 has a main portion 111 and a first side sealing edge 112 extending outward from one side of the main portion 111. The main portion 111 internally defines an accommodating cavity adapted to a shape of the electrode assembly 12, and the electrode assembly 12 is placed in the accommodating cavity. The first side sealing edge 112 is folded and fastened to a first side wall 1113, and the first connecting member 21 is fastened to the first side sealing edge 112. The tab 13 is electrically connected to the electrode assembly 12, and the tab 13 extends out of the main portion 111.

In some embodiments, the tab 13 is configured to be electrically connected to a charge-discharge circuit of the electric device. It may be understood that a connection method between the tab 13 and the charge-discharge circuit of the electric device is not specifically limited in these embodiments of this application, and may be adaptively adjusted according to actual usage requirements. For example, in some embodiments, the tab 13 may be electrically connected to the charge-discharge circuit of the electric device through a flexible circuit board connector. For another example, in other embodiments, the tab 13 may be in contact conduction with the charge-discharge circuit of the electric device through metal contacts.

In some embodiments, with reference to FIG. 4 in combination with FIG. 2, the secondary battery body 10 is overall substantially a flat rectangular parallelepiped, that is, the main portion 111 is overall substantially a flat rectangular parallelepiped. The main portion 111 may include a first main wall 1111, a second main wall 1112, a first side wall 1113, a second side wall 1114, a third side wall 1115, and a fourth side wall 1116. The first side wall 1113, the second side wall 1114, the third side wall 1115, and the fourth side wall 1116 are connected end to end in sequence. Four sides of the first main wall 1111 are respectively connected to one end of the first side wall 1113, one end of the second side wall 1114, one end of the third side wall 1115, and one end of the fourth side wall 1116. Four sides of the second main wall 1112 are respectively connected to another end of the first side wall 1113, another end of the second side wall 1114, another end of the third side wall 1115, and another end of the fourth side wall 1116. The first main wall 1111, the second main wall 1112, the first side wall 1113, the second side wall 1114, the third side wall 1115, and the fourth side wall 1116 together enclose the aforementioned accommodating cavity. The first main wall 1111 and the second main wall 1112 are disposed opposite along a first direction X; the second side wall 1114 and the fourth side wall 1116 are disposed opposite along a second direction Y; the first side wall 1113 and the third side wall 1115 are disposed opposite along a third direction Z; and any two of the third direction Z, the second direction Y, and the first direction X are perpendicular to each other.

It should be noted that the first main wall 1111 and the second main wall 1112 mentioned herein respectively correspond to two large surfaces of the electrode assembly 12 to be described below, and the two large surfaces of the electrode assembly 12 are two parts with the largest areas on the electrode assembly 12. To be specific, the first main wall 1111 and the second main wall 1112 are disposed opposite along the first direction X, that is, the first main wall 1111 and the second main wall 1112 are disposed opposite along a thickness direction of the electrode assembly 12.

The second side wall 1114 and the fourth side wall 1116 respectively correspond to two side surfaces with the smallest areas of the electrode assembly 12 to be described below. To be specific, the second side wall 1114 and the fourth side wall 1116 are disposed opposite along the second direction Y, that is, the second side wall 1114 and the fourth side wall 1116 are disposed opposite along a width direction of the electrode assembly 12.

The first side wall 1113 and the third side wall 1115 respectively correspond to two side surfaces with moderate areas of the electrode assembly 12 to be described below. To be specific, the first side wall 1113 and the third side wall 1115 are disposed opposite along the third direction Z, that is, the first side wall 1113 and the third side wall 1115 are disposed opposite along the length direction of the electrode assembly 12.

In some embodiments, as shown in FIG. 4, the first side sealing edge 112 is provided with a slot (not shown) for clamping the first connecting member 21. Specifically, the first side sealing edge 112 is a double-folded edge, which includes a first bending portion 1121, a first extending portion 1122, a second bending portion 1123, and a second extending portion 1124; where the first bending portion 1121 is formed by bending and extending toward a direction facing the first side wall 1113; the first extending portion 1122 is connected to an end of the first bending portion 1121 away from the first side wall 1113, and the first extending portion 1122 extends along a direction parallel to the first direction X; the second bending portion 1123 is formed by first bending and extending from the first extending portion 1122 toward the direction facing the first side wall 1113 and then bending and extending toward a direction parallel to the third direction Z; the second extending portion 1124 extends along a direction parallel to the first direction X toward the first bending portion 1121; the first bending portion 1121, the first extending portion 1122, the second bending portion 1123, and the second extending portion 1124 together enclose the aforementioned slot.

In some embodiments, the second extending portion 1124 is adhesively fastened to the first side wall 1113. As an example, the second extending portion 1124 may be adhesively fastened to the first side wall 1113 using, but not limited to, double-sided tape, glue, or tape. Examples of such glue include hot melt glue, animal glue, and synthetic resin glue.

The specific structure of the pouch bag body 11 is not specifically limited in these embodiments of this application, as long as it has a barrier property, resistance to electrolyte corrosion, and light weight. Materials for making such a pouch bag body 11 may include, but are not limited to, aluminum-plastic film, plastic materials, metal materials, or composite materials of plastic and metal. For example, the pouch bag body 11 may be made of aluminum-plastic film.

In the foregoing embodiments, as shown in FIG. 2 to FIG. 4, the secondary battery body 10 is exemplified as a flat rectangular parallelepiped. Those skilled in the art should understand that a shape of the secondary battery body 10 is not limited thereto, and it may vary with a shape of the electrode assembly 12, as long as the first side sealing edge 112 extends from the first side wall 1113 of the main portion 111.

In some embodiments, as shown in FIG. 5, the electrode assembly 12 is substantially a flat rectangular parallelepiped, which includes a first electrode plate 121, a second electrode plate 122, and a separator 123 separating the first electrode plate 121 from the second electrode plate 122. In some embodiments, the first electrode plate 121, the separator 123, and the second electrode plate 122 are alternately stacked, or are stacked once and wound multiple times to obtain different types of electrode assemblies 12.

The first electrode plate 121 is electrically connected to a first tab 131 of the tab 13, and the second electrode plate 122 is electrically connected to a second tab 132 of the tab 13. As shown in FIG. 2 or FIG. 3, the first tab 131 and the second tab 132 extend from the same side of the electrode assembly 12 out of the third side wall 1115, and the first tab 131 and the second tab 132 are spaced apart along the third direction Z.

In the following descriptions, the first electrode plate 121 is exemplified as a positive electrode plate, and the second electrode plate 122 is exemplified as a negative electrode plate.

In some embodiments, the first electrode plate 121 may include a first current collector (not shown) and a first active material layer (not shown), and the first active material layer is disposed on at least one surface of the first current collector.

As an example, the first current collector may at least include, but is not limited to, one or more of conductive metal sheets such as aluminum mesh, aluminum foil, or copper foil.

The first active material layer may at least include, but is not limited to, one or more of lithium cobalt oxide, lithium nickel cobalt manganese oxide, lithium nickel cobalt aluminate, lithium manganese oxide, lithium nickel oxide, lithium iron manganese phosphate, lithium vanadium phosphate, lithium iron phosphate, and lithium-rich manganese-based material.

In some embodiments, the second electrode plate 122 may include a second current collector (not shown) and a second active material layer (not shown), and the second active material layer is disposed on at least one surface of the second current collector.

As an example, the second current collector may at least include, but is not limited to, either or both of conductive metal sheets such as nickel foil and copper foil.

The second active material layer may at least include, but is not limited to, one or more of artificial graphite, natural graphite, soft carbon, hard carbon, graphene, mesocarbon microbeads, silicon-based material, tin-based material, lithium carbonate, or other metals capable of forming alloys with lithium.

In some embodiments, the separator 123 includes, but is not limited to, at least one of polyethylene, polypropylene, polyethylene terephthalate, polyimide, or aramid. For example, polyethylene includes at least one component selected from high-density polyethylene, low-density polyethylene, or ultra-high molecular weight polyethylene. In particular, polyethylene and polypropylene can effectively prevent short circuits and improve stability of the secondary battery through a shutdown effect.

A surface of the separator 123 may further include a porous layer, the porous layer is disposed on at least one surface of the separator 123, the porous layer includes inorganic particles and a binder, the inorganic particles may be selected from, but are not limited to, one or more of aluminum oxide, silicon oxide, magnesium oxide, titanium oxide, hafnium dioxide, tin oxide,, nickel oxide, zinc oxide, calcium oxide, zirconium oxide, yttrium oxide, silicon carbide, boehmite, aluminum hydroxide, magnesium hydroxide, calcium hydroxide, and barium sulfate. The binder may be selected from, but is not limited to, one or more of polyvinylidene fluoride, vinylidene fluoride-hexafluoropropylene copolymer, polyamide, polyacrylonitrile, polyacrylate, polyacrylic acid, polyacrylate salt, sodium carboxymethyl cellulose, polyvinylpyrrolidone, polyvinyl ether, polymethyl methacrylate, polytetrafluoroethylene, or polyhexafluoropropylene.

The porous layer can enhance the heat resistance, oxidation resistance, and electrolyte wettability of the separator 123, and improve adhesion between the separator 123 and the first electrode plate 121 or the second electrode plate 122.

Regarding the first connecting member 21, in some embodiments, the first connecting member 21 includes a first fastening portion 211 and a first connecting portion 212 connected to the first fastening portion 211, the first fastening portion 211 is fastened to the first side sealing edge 112, the first connecting portion 212 extends beyond one end of the first side sealing edge 112 along the second direction Y, and the first connecting portion 212 is configured to be detachably connected to the electric device to fasten the secondary battery in the battery compartment of the electric device.

As mentioned in the background, secondary batteries are typically adhesively fastened to the bottom of the battery compartment by attaching double-sided tape to their bottom large surface (the first main wall 1111 or the second main wall 1112), and foam is attached to the top large surface. Therefore, subsequent disassembly and replacement of the secondary battery are inconvenient, and because the double-sided tape inevitably occupies part of a longitudinal space of the battery compartment in the third direction Z, a space available for accommodating the secondary battery in the limited battery compartment is reduced, resulting in a loss of volumetric energy density of the secondary battery.

In the secondary battery according to this application, the first connecting member 21 is fastened to a side surface of the secondary battery body, and the secondary battery body 10 is detachably fastened in the battery compartment through the first connecting portion 212. Therefore, there is no need to attach double-sided tape to the large surface (the first main wall 1111 or the second main wall 1112), the longitudinal space of the secondary battery body in the third direction Z is increased, and thus the volumetric energy density of the secondary battery is improved.

The following compares the secondary battery in the background with the secondary battery according to this application.

The secondary battery in the background (double-sided tape+wrapping film): 0.1 mm to 0.25 mm (thickness of double-sided tape)+0.12 mm (thickness of wrapping film)=0.22 mm to 0.35 mm. For an exemplary battery with a thickness of 4.5 mm, a loss of volumetric energy density is approximately 4.9% to 7.8%.

The secondary battery according to this application: if the device end provides clearance for a screw hole position, for an exemplary battery with a width of 6.5 mm, an energy density loss is only reflected in a battery width increase of about 0.4 mm, with an energy density loss of approximately 0.6%.

In some embodiments, with reference to FIG. 6 in combination with FIG. 2 and FIG. 4, the first connecting member 21 is substantially a thin plate structure. The first fastening portion 211 is inserted into the slot, and the first fastening portion 211 abuts against the first extending portion 1122 and the second extending portion 1124, respectively. The first connecting portion 212 is integrally connected to one end of the first fastening portion 211 not inserted into the slot and extends beyond one end of the first side sealing edge 112 along the second direction Y, and the first connecting portion 212 is provided with a first through hole 21a. When the secondary battery body 10 is placed in the battery compartment, the first through hole 21a may at least partially overlap with a screw hole, and a threaded fastener may pass through the first through hole 21a and be screw-fixed to the screw hole, thereby locking the secondary battery placed in the battery compartment.

The advantages of this arrangement are as follows. First, due to the structural characteristics of the first bending portion 1121 and the second bending portion 1123, even after bending, there is still a certain gap; and the first fastening portion 211 is fastened in the slot formed by the first bending portion 1121 and the second bending portion 1123. Then, in the third direction Z, a width of an entirety formed by the first connecting member 21 and the first side sealing edge 112 is less than a width of an entirety formed with the first connecting member 21 directly fastened to the side of the first extending portion 1122 away from the second extending portion 1124. In this way, the volumetric energy density of the secondary battery in the third direction Z is further increased. Second, since the second extending portion 1124 is fastened to the first side wall 1113, the first fastening portion 211 may be fastened through interference fit with the first extending portion 1122 and the second extending portion 1124, thus the first connecting member 21 does not require additional adhesive members for fastening, saving the manufacturing cost of the secondary battery. Third, the secondary battery according to this application adopts threaded connection with high connection strength, and therefore compared with contact pressing to fasten secondary batteries in conventional electric devices such as mobile phones, this improves drop resistance performance of an electric device to cope with conditions such as vibration or impact.

It can be understood that the detachable connection method between the first connecting portion 212 and the electric device is actually diverse, and their structures can be adaptively adjusted according to actual usage requirements. For example, in other embodiments, the first connecting portion 212 is provided with a latch, and the electric device is provided with a catch at a position corresponding to the latch. The catch engages with the latch, which can also achieve detachable connection between the secondary battery and the electric device.

For ease of assembly and disassembly of the secondary battery, in some embodiments, as shown in FIG. 6, the first connecting portion 212 includes a first connecting segment 2121 and a second connecting segment 2122, the first connecting segment 2121 extends from an end of the first fastening portion 211 away from the slot in an opposite direction of the second direction Y, the second connecting segment 2122 is connected to the first fastening portion 211 through the first connecting segment 2121, and the extending direction of the second connecting segment 2122 is parallel to the third direction Z. The second connecting segment 2122 is provided with the aforementioned first through hole 21a. Correspondingly, the position of the screw hole of the electric device may define an avoidance slot (not shown), and a bottom of the avoidance slot communicates with the screw hole.

When the secondary battery is accommodated in the battery compartment, the second connecting segment 2122 is located in the avoidance slot, the first through hole 21a may at least partially overlap with the screw hole, and the first through hole 21a and the screw hole are both facing a user during assembly and disassembly, so that the threaded fastener can conveniently pass through the first through hole 21a and be screw-fixed to the screw hole, thereby locking the secondary battery placed in the battery compartment.

It can be understood that an extending direction of the second connecting segment 2122 is not specifically limited in these embodiments of this application. For example, as shown in FIG. 3, in some embodiments, the extending direction of the second connecting segment 2122 is parallel to the third direction Z, and the second connecting segment 2122 extends toward a direction facing the main portion 111. For another example, as shown in FIG. 2, in other embodiments, the extending direction of the second connecting segment 2122 is parallel to the third direction Z, and the second connecting segment 2122 extends toward the direction away from the main portion 111.

Certainly, the specific structure of the first connecting portion 212 is not limited thereto. In some embodiments, as shown in FIG. 8 to FIG. 10, the first connecting portion 212 only has the first connecting segment 2121, and the first connecting member 21 is overall a thin straight-strip plate structure. The first connecting segment 2121 is provided with the first through hole 21a. In this case, the position of the screw hole of the electric device may not define an avoidance slot, but the screw hole of the electric device needs to penetrate one side wall of the battery compartment along the third direction Z. Thus, the threaded fastener passes through the first through hole 21a and is screw-fixed to the screw hole.

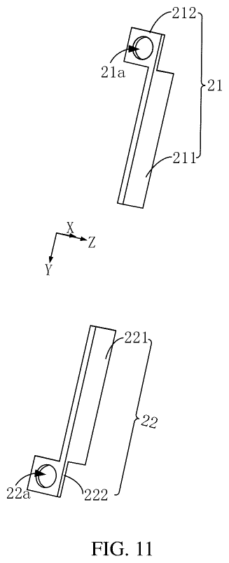

Further, in other embodiments, as shown in FIG. 11, the first connecting portion 212 only has the first connecting segment 2121, the first connecting segment 2121 is disposed at an angle to the first fastening portion 211, and the first connecting segment 2121 is provided with the first through hole 21a.

It should be noted that the first connecting member 21 should have good bending resistance strength and impact resistance strength, thereby maintaining stable connection between the secondary battery body 10 and the electric device. Materials for manufacturing such a first connecting member 21 include, but are not limited to, cemented carbide, high-toughness ceramic, or plastic steel. If the first connecting member 21 is made of conductive material such as cemented carbide, insulation treatment needs to be performed on its outer surface to prevent short-circuits of an electronic component inside the electric device or the secondary battery due to mixing.

In some embodiments, the secondary battery includes a second connecting member 22, the second connecting member 22 includes a second fastening portion 221 and a second connecting portion 222 connected to the second fastening portion 221, the second fastening portion 221 is fastened to the first side sealing edge 112, the second connecting portion 222 extends beyond another end of the first side sealing edge 112 along the second direction Y, and the second connecting portion 222 is configured to be detachably connected to the electric device to fasten the secondary battery in the battery compartment of the electric device.

In some embodiments, with continued reference to FIG. 6 in combination with FIG. 2 and FIG. 4, the second connecting member 22 is substantially a thin plate structure. The second fastening portion 221 is inserted into the slot, and the first fastening portion 211 abuts against the first extending portion 1122 and the second extending portion 1124 separately. The second connecting portion 222 is integrally connected to one end of the second fastening portion 221 not inserted into the slot, and extends beyond another end of the first side sealing edge 112 along the second direction Y, and the second connecting portion 222 is provided with a second through hole 22a. When the secondary battery body 10 is placed in the battery compartment, the second through hole 22a may at least partially overlap with another screw hole, and another threaded fastener may pass through the second through hole 22a and be screw-fixed to the another screw hole, thereby locking the secondary battery placed in the battery compartment together with the first connecting member 21.

For ease of assembly and disassembly of the secondary battery, in some embodiments, as shown in FIG. 6, the second connecting portion 222 includes a third connecting segment 2221 and a fourth connecting segment 2222, the third connecting segment 2221 extends from one end of the second fastening portion 221 away from the slot along the second direction Y, the fourth connecting segment 2222 is connected to the second fastening portion 221 through the third connecting segment 2221, and an extending direction of the fourth connecting segment 2222 is parallel to the third direction Z. The fourth connecting segment 2222 is provided with the aforementioned second through hole 22a. Correspondingly, the position of the another screw hole of the electric device may define another avoidance slot, and a bottom of the another avoidance slot communicates with the another screw hole.

It can be understood that the extending direction of the fourth connecting segment 2222 is not specifically limited in these embodiments of this application. For example, as shown in FIG. 3, in some embodiments, the extending direction of the fourth connecting segment 2222 is perpendicular to the extending direction of the third connecting segment 2221, and the fourth connecting segment 2222 extends toward the direction facing the main portion 111. For another example, as shown in FIG. 2, in other embodiments, the extending direction of the fourth connecting segment 2222 is perpendicular to the extending direction of the third connecting segment 2221, and the fourth connecting segment 2222 extends toward the direction away from the main portion 111.

Certainly, the specific structure of the second connecting portion 222 is not limited thereto, in some embodiments, as shown in FIG. 8 to FIG. 10, the second connecting portion 222 may only have the third connecting segment 2221, that is, the second connecting member 22 is overall a thin straight-strip plate structure. The third connecting segment 2221 is provided with the second through hole 22a. In this case, the position of the another screw hole of the electric device may not define the another avoidance slot, but the another screw hole of the electric device needs to penetrate one side wall of the battery compartment along the third direction Z. Thus, the threaded fastener passes through the second through hole 22a and is screw-fixed to the another screw hole.

It should be noted that the second connecting member 22 should have good bending resistance strength and impact resistance strength, thereby maintaining stable connection between the secondary battery body 10 and the electric device. Materials for manufacturing such a second connecting member 22 include, but are not limited to, cemented carbide, high-toughness ceramic, or plastic steel. If the second connecting member 22 is made of conductive material such as cemented carbide, insulation treatment needs to be performed on its outer surface to prevent short-circuits of an electronic component inside the electric device or the secondary battery due to mixing.

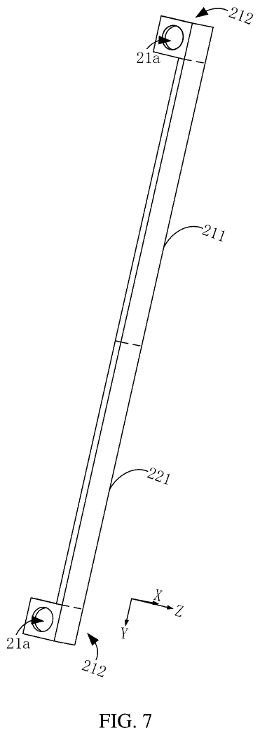

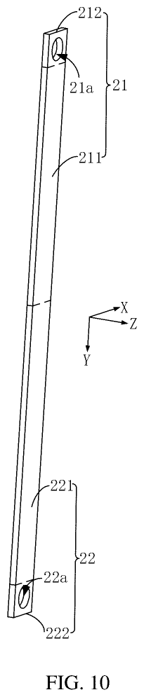

In some embodiments, as shown in FIG. 7 or FIG. 10, the second connecting member 22 and the first connecting member 21 may be two parts on one component. For example, the first fastening portion 211 and the second fastening portion 221 are integrally formed.

In specific implementation, the overall structure formed by the first fastening portion 211 and the second fastening portion 221 may be first placed on the to-be-folded first side sealing edge 112; then, the overall structure formed by the first fastening portion 211 and the second fastening portion 221 is folded together with the first side sealing edge 112; then, the second extending portion 1124 is adhesively fastened to the first side wall 1113, so that the overall structure formed by the first fastening portion 211 and the second fastening portion 221 abuts against the first extending portion 1122 and the second extending portion 1124 separately.

In some embodiments, the first through hole 21a and/or the second through hole 22a are screw holes. Certainly, the first through hole 21a and/or the second through hole 22a are through holes.

### Second Embodiment

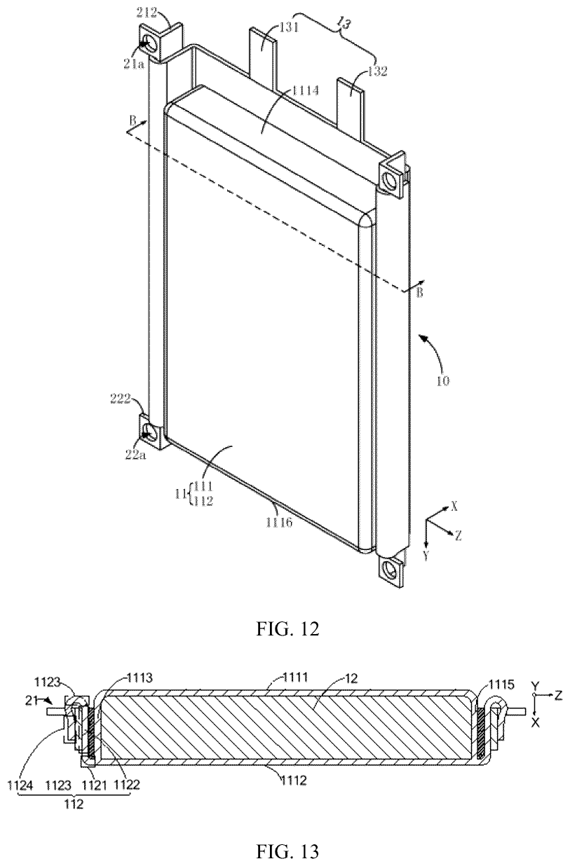

FIG. 12 is a schematic diagram of a structure of a secondary battery provided in a second embodiment of this application, and FIG. 13 is a cross-sectional view along line B-B in FIG. 12.

As shown in FIG. 13, the first side sealing edge 112 is still a double-folded edge, which also includes a first bending portion 1121, a first extending portion 1122, and a second extending portion 1124. The formation methods of the first bending portion 1121 and the first extending portion 1122 are the same as those of the first bending portion 1121 and the first extending portion 1122 in the aforementioned double-folded edge. Different from the aforementioned the first side sealing edge 112 that is a double-folded edge, the second bending portion 1123 is first bent and extended toward the direction away from the first side wall 1113 and then bent and extended to a direction parallel to the third direction Z; the second extending portion 1124 extends along the direction parallel to the third direction Z toward the direction away from the second bending portion 1123; and the first extending portion 1122, the second bending portion 1123, and the second extending portion 1124 together enclose the aforementioned slot.

In some embodiments, the first extending portion 1122 is adhesively fastened to the first side wall 1113. As an example, the first extending portion 1122 may be adhesively fastened to the first side wall 1113 using, but not limited to, double-sided tape, glue, or tape. Examples of such glue include hot melt glue, animal glue, or synthetic resin glue.

The specific connection method of the first side sealing edge 112 and the components connected thereto is not specifically limited herein. For example, when the first connecting member 21, the second connecting member 22, the first connecting member 21 and the second connecting member 22 are two parts of one component, one of the three may abut against the first extending portion 1122 and the second extending portion 1124. Alternatively, one of the three may be adhesively fastened to the first extending portion 1122 and the second extending portion 1124.

### Third Embodiment

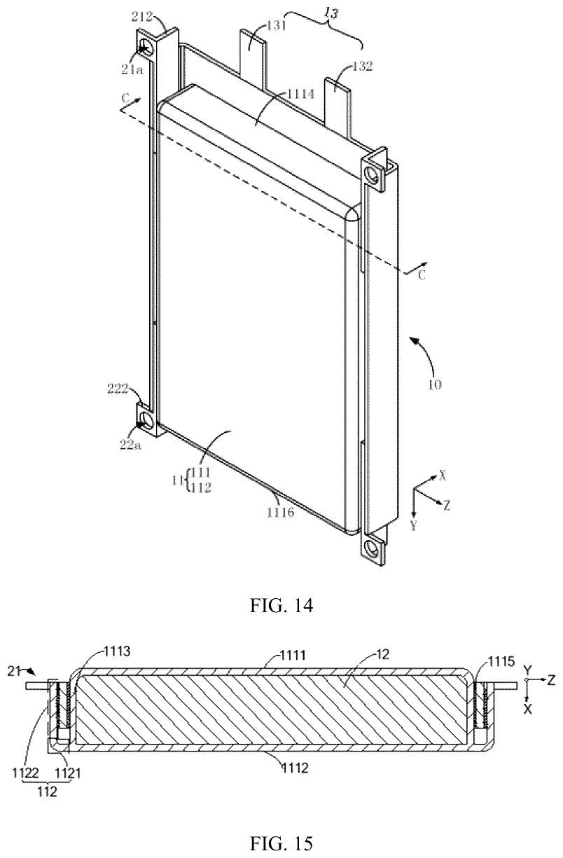

FIG. 14 is a schematic diagram of a structure of a secondary battery provided in a third embodiment of this application, and FIG. 15 is a cross-sectional view of the secondary battery shown in FIG. 14 along line C-C.

As shown in FIG. 15, in some embodiments, the first side sealing edge 112 is a single-folded edge, which includes a first bending portion 1121 and a first extending portion 1122; the first bending portion 1121 is formed by bending and extending toward the direction facing the first side wall 1113; the first extending portion 1122 is connected to one end of the first bending portion 1121 away from the first side wall 1113, and the first extending portion 1122 extends along a direction parallel to the third direction Z; the first side wall 1113, the first bending portion 1121, and the first extending portion 1122 together enclose the aforementioned slot.

When the first connecting member 21, the second connecting member 22, the first connecting member 21 and the second connecting member 22 are two parts of one component, one of the three may be adhesively fastened to the first extending portion 1122 and the first side wall 1113.

The above descriptions are only embodiments of this application, and are not intended to limit the patent scope of this application. Any equivalent structure or equivalent process transformation made using the contents of the specification and drawings of this application, or directly or indirectly applied in other related technical fields, is similarly included in the patent protection scope of this application.

What is claimed is:

1. A secondary battery, comprising a secondary battery body, wherein the secondary battery body has a main portion and a first side sealing edge; the main portion comprises a first main wall, a second main wall, and a first side wall; along a first direction, the first main wall and the second main wall are disposed opposite to each other; the first side wall is connected between the first main wall and the second main wall; and the first side sealing edge extends out of the first side wall and is folded and fastened to the first side wall; wherein
the secondary battery comprises a first connecting member, the first connecting member comprises a first fastening portion and a first connecting portion connected to the first fastening portion, the first fastening portion is fastened to the first side sealing edge, the first connecting portion extends beyond one end of the first side sealing edge along a second direction, and the first connecting portion is configured to be detachably connected to an electric device to fasten the secondary battery in a battery compartment of the electric device, wherein the second direction is perpendicular to the first direction.

2. The secondary battery according to claim 1, wherein the first connecting portion is provided with a first through hole, the first through hole is configured to receive a threaded fastener to screw-fastening the first connecting portion to the electric device.

3. The secondary battery according to claim 2, wherein the first connecting portion comprises a first connecting segment and a second connecting segment, and the first connecting segment extends from one end of the first fastening portion along the second direction;
the second connecting segment is connected to the first fastening portion through the first connecting segment, and the second connecting segment extends along a direction parallel to a third direction; wherein any two of the third direction, the second direction, and the first direction are perpendicular to each other; and
the first through hole is provided in the second connecting segment.

4. The secondary battery according to claim 3, wherein the secondary battery comprises a second connecting member, the second connecting member comprises a second fastening portion and a second connecting portion connected to the second fastening portion, the second fastening portion is fastened to the first side sealing edge, the second connecting portion extends beyond another end of the first side sealing edge along the second direction, and the second connecting portion is configured to be detachably connected to the electric device to fasten the secondary battery in the battery compartment of the electric device.

5. The secondary battery according to claim 4, wherein the first fastening portion and the second fastening portion are integrally formed.

6. The secondary battery according to claim 4, wherein the second connecting portion is provided with a second through hole, the second through hole is configured to receive a threaded fastener to screw-fastening the second connecting portion to the electric device.

7. The secondary battery according to claim 6, wherein the second connecting portion comprises a third connecting segment and a fourth connecting segment, and the third connecting segment extends from one end of the second fastening portion along the second direction;
the fourth connecting segment is connected to the second fastening portion through the third connecting segment, and the fourth connecting segment extends in a direction parallel to the third direction; wherein any two of the third direction, the second direction, and the first direction are perpendicular to each other; and
the second through hole is provided in the fourth connecting segment.

8. The secondary battery according to claim 3, wherein the first side sealing edge is a double-folded edge; and
the first side sealing edge comprises a first bending portion, a first extending portion, a second bending portion, and a second extending portion; the first bending portion extends outward from the first side wall, the first extending portion is connected to the first bending portion, the second extending portion is connected to the first extending portion through the second bending portion; the first bending portion, the first extending portion, the second bending portion, and the second extending portion together enclose a slot, and the first fastening portion is fastened to the slot.

9. The secondary battery according to claim 8, wherein
the second extending portion is adhesively fastened to the first side wall.

10. The secondary battery according to claim 8, wherein the first extending portion and the second extending portion abut against the first fastening portion.

11. The secondary battery according to claim 1, wherein the first side sealing edge is a single-folded edge; and
the first side sealing edge comprises a first bending portion and a first extending portion, the first bending portion extends outward from the first side wall, the first extending portion is connected to the first bending portion; the first bending portion, the first extending portion, and the first side wall together enclose a slot, and the first fastening portion is fastened to the slot.

12. An electric device, comprising the secondary battery according to claims1.

13. The electric device according to claim 12, wherein the first connecting portion is provided with a first through hole, the first through hole is configured to receive a threaded fastener to screw-fastening the first connecting portion to the electric device.

14. The electric device according to claim 13, wherein the first connecting portion comprises a first connecting segment and a second connecting segment, and the first connecting segment extends from one end of the first fastening portion along the second direction;
the second connecting segment is connected to the first fastening portion through the first connecting segment, and the second connecting segment extends along a direction parallel to a third direction; wherein any two of the third direction, the second direction, and the first direction are perpendicular to each other; and
the first through hole is provided in the second connecting segment.

15. The electric device according to claim 14, wherein the secondary battery comprises a second connecting member, the second connecting member comprises a second fastening portion and a second connecting portion connected to the second fastening portion, the second fastening portion is fastened to the first side sealing edge, the second connecting portion extends beyond another end of the first side sealing edge along the second direction, and the second connecting portion is configured to be detachably connected to the electric device to fasten the secondary battery in the battery compartment of the electric device.

16. The electric device according to claim 15, wherein the first fastening portion and the second fastening portion are integrally formed.

17. The electric device according to claim 15, wherein the second connecting portion is provided with a second through hole, the second through hole is configured to receive a threaded fastener to screw-fastening the second connecting portion to the electric device.

18. The electric device according to claim 17, wherein the second connecting portion comprises a third connecting segment and a fourth connecting segment, and the third connecting segment extends from one end of the second fastening portion along the second direction;
the fourth connecting segment is connected to the second fastening portion through the third connecting segment, and the fourth connecting segment extends in a direction parallel to the third direction; wherein any two of the third direction, the second direction, and the first direction are perpendicular to each other; and
the second through hole is provided in the fourth connecting segment.

19. The electric device according to claim 14, wherein the first side sealing edge is a double-folded edge; and
the first side sealing edge comprises a first bending portion, a first extending portion, a second bending portion, and a second extending portion, the first bending portion extends outward from the first side wall, the first extending portion is connected to the first bending portion, the second extending portion is connected to the first extending portion through the second bending portion, the first bending portion, the first extending portion, the second bending portion, and the second extending portion together enclose a slot, and the first fastening portion is fastened to the slot.

20. The electric device according to claim 19, wherein the first extending portion and the second extending portion abut against the first fastening portion.
